(19) United States
(12) Patent Application Publication
(10) Pub. No.: US 2020/0322069 A1
(43) Pub. Date: Oct. 8, 2020

(54) COMBAT NET RADIO NETWORK ANALYSIS TOOL

(71) Applicant: Cervus Defence and Security Limited, Pewsey Iltshire (GB)

(72) Inventor: Christopher Baddeley, Tiverton (GB)

(21) Appl. No.: 16/488,474

(22) PCT Filed: Feb. 22, 2018
(86) PCT No.: PCT/GB2018/050463

§ 371 Date: Aug. 23, 2019

(30) Foreign Application Priority Data
Feb. 23, 2017 (GB) 1702941.4

(51) Int. Cl. H04B 17/18; H04B 17/29; H04W 24/10

(52) U.S. Cl. CPC H04B 17/18; H04W 84/005; H04W 24/10; H04B 17/29

(57) ABSTRACT

The present invention relates to analysis for connectivity and operation of radio networks, in particular combat radio networks for voice communication. There is provided technologies for collecting radio voice communications between a number of radio units (or nodes) across a radio network and applying audio analytics to the communications to determine connectivity measures (or properties) between radio units of the network, and the time evolution of said measures. A method of the present invention is a method of operating a radio network, the radio network comprising a plurality of radio units. The radio units may be deployed in a field exercise, for example in a specific geographical locale. Each radio unit is operable to transmit and receive messages as audio signals over the radio network. The method may comprise: recording, at each of one or more transmitting radio units of the plurality of radio units, respective transmitted audio signals for messages transmitted from the transmitting radio unit, recording, at each of one or more receiving radio units of the plurality of radio units, respective received audio signals for messages received by the receiving radio unit, and identifying, for each transmitted audio signal, the received audio signals for messages common to the transmitted audio signal and the received messages to thereby generate one or more measures of connectivity between radio units of the plurality.

### FIELD OF THE INVENTION

The present invention relates to analysis for connectivity and operation of radio networks, in particular combat radio networks for voice communication.

### BACKGROUND OF THE INVENTION

Radio networks, where spoken word messages are exchanged by groups of radios, have been widely used for many years where quick communication is needed to coordinate people deployed over a moderate geographical area. Examples of such situations include emergency services (e.g. police, fire services and paramedics etc.) operating within a particular locale, and the armed forces during field deployments.

Such communication may be used to provide situational awareness for a given user (through intelligence and situational changes communicated by other users). This allows orders to be effectively given, and local information or intelligence to be exchanged and updated. Radio networks (such as combat net radio systems) are of particular importance to Combat Arms units (deployed soldiers at the tactical level—Infantry, Cavalry and attached specialists), of which the majority of users may only be required to communicate using voice communications. A radio network, therefore, is often used to allow a number of people (or units) who are distributed across a geographical locale to effectively operate in a coordinated manner. In this way a group of units may be able to move through terrain and engage with a developing situation as if the group was a single entity.

However, radio networks, including combat net radio, tend to be subject to radio interference and signal degradation. This can be caused by overt action, such as signal jamming, or passive interference, such as atmospheric conditions, range or intervening terrain. Such interference can result in communications problems. In the worst cases these can result in some radios in the network being unable to receive communications from, or transmit communications to, other radios, such that respective communications links between certain units are totally severed. This can result in orders being missed, intelligence being lost, and ultimately a lack of coordination between units. In such cases one group of units may, in effect, be fractured into several groups, which are unable to reliably communicate with each other. Therefore, rather than a group of units operating as a single entity, in poor communication scenarios, the group of units may operate more like several different entities. More problematically, the units in a given group which can all communicate with each other, may not all be able to communicate with other units to the same degree. Thus, even for units in a given group, those units may have different levels of information available to them. Therefore the units may have differing levels of situational awareness. These issues may ultimately lead to confusion and disorganization during the field deployment. As such, the ability to communicate effectively and efficiently is often paramount to success.

Radio networks (and combat net radio in particular) are used across a wide spectrum of operations, such as providing emergency services, peace keeping, counter-insurgency, warfighting. Given this, it would be desirable to measure the effectiveness of the ability to pass information across such radio networks, to analyse the full effects of communication loses, so as to develop mitigation strategies. Indeed, in both the military and the emergency services large scale training events (such as training incidents and military field exercises) are regularly staged to train for and analyse how particular operational systems perform in the context of large incidents, and it would be desirable to take account of the impact of transient communications issues during such training.

### SUMMARY OF THE INVENTION

As communicating effectively is central to the success of such operations there is, therefore, a need to measure the capability of radio networks during deployment, to enable the assessment of an organisation's ability to employ these radio networks effectively and also to assist in the evaluation, acceptance and design of future communications systems.

The invention provides a method of collecting radio voice communications between a number of radio units (or nodes) across a radio network and applying audio analytics to the communications to determine connectivity measures (or properties) between radio units of the network, and the time evolution of said measures.

This advantageously allows communication across the network to be accurately measured and the network to be adjusted accordingly.

The invention therefore provides methods of operating a radio network (such as a combat net radio network), the radio network comprising a plurality of radio units. The radio units may be deployed in a field exercise, for example in a specific geographical locale. Each radio unit is operable to transmit and receive messages as audio signals over the radio network. The method may comprise: recording, at each of one or more transmitting radio units of the plurality of radio units, respective transmitted audio signals for messages transmitted from the transmitting radio unit, recording, at each of one or more receiving radio units of the plurality of radio units, respective received audio signals for messages received by the receiving radio unit, and identifying, for each transmitted audio signal, the received audio signals for messages common to the transmitted audio signal and the received messages to thereby generate one or more measures of connectivity between radio units of the plurality.

The step of identifying may be viewed as applying to transmitted and received audio signals. For example the step of identifying may take the form of identifying for each of at least some of the transmitted audio signals, correspondence between the transmitted audio signals and one or more received audio signals for the same message as transmitted audio signal. The step of identifying may be viewed as a step of linking transmitted audio signals with respective ones of the received audio signals having a message in common with the transmitted audio signals. The measures of connectivity may be generated in a separate step. To that end the method may comprise generating one or more measures of connectivity between radio units of the plurality from the identified audio signals (or the linked audio signals or the identified correspondence of transmitted and received audio signals).

The recording of transmitted and received audio signals at a radio unit may be carried out by a capture unit connected to (or in communication with) said radio unit,

Typically, each radio unit (or the respective capture unit connected to each radio unit) records a series of geographical coordinates of the radio unit during the field exercise. Particularly geographical coordinates may be recorded for the transmitted audio signals and for the received audio signals at said radio unit.

The step of identifying may be performed separately from the other steps of the above method (for example after a field exercise or deployment is finished) and form part of a further method further comprising receiving, from each of the plurality of radio units: (a) respective transmitted audio signals for messages transmitted from the radio unit; and (b) respective received audio signals for messages received by the radio unit.

Typically, each of the transmitted audio signals and the received audio signals is associated with geographical coordinates of the respective radio unit representing the positon of the radio unit when recording the audio signal.

It will be appreciated that whilst a distinction is drawn between transmitted audio signals and received audio signals the general term audio signals may be used herein to refer to received audio signals and transmitted audio signals.

In some examples of the above methods, the series of geographical coordinates may include one or more timestamps based on a timing source common to the radio units.

In some examples of the above methods, the one or more measures of connectivity may comprises a respective range for each radio unit (or between pairs of radio units), based at least in part on the geographical coordinates recorded for the parts of the received audio signals of the other radio units identified as corresponding to transmitted audio signals of the radio unit.

The above methods may further comprise a step of outputting a graph of connectivity between radio units of the plurality based on the measures of connectivity. The graph representing time dependent measure of connectivity measure may comprise a respective completion rate for each transmitted audio signal.

Said outputting typically comprises plotting, using the series of geographical coordinates recorded at the radio units, at least part of the connectivity measure onto a topographical representation of a locale in which the radio units are deployed. As part of the plotting the respective range for one or more of the radio units may be indicated on the topographical representation.

In some examples of the above methods, the identifying is based on an audio analytics comparison of the transmitted audio signal and the received audio signals. The audio analytics comparison may be based at least in part on performing voice recognition processing on the transmitted audio signal and the received audio signals.

Often, the audio analytics comparison is based at least in part on performing audio fingerprint processing on the transmitted audio signal and the received audio signals. For example, the audio analytics comparison typically, comprises, performing audio fingerprint processing on the transmitted audio signal to generate audio fingerprint data for the message of the transmitted audio signal; and comparing the audio fingerprint data for the transmitted audio signal with audio fingerprint data for the received audio signals.

In some examples, the method comprises performing automatic speech recognition processing on the transmitted audio signal to generate a message transcript for the message of the transmitted audio signal. For a transmitted audio signal, each corresponding identified received audio signal may be associated (or tagged) with the message transcript for the transmitted audio signal.

In some examples of the above methods, the automatic speech recognition is performed as part of the audio analytics comparison. In this case the audio analytics comparison may comprise comparing the message transcript for the transmitted audio signal with message transcripts of the messages of the received audio signals.

In some examples of the above methods, each audio signal may be associated (or tagged) with one or more message categories based on the message transcript of the message of the audio signal.

In some examples of the above methods, the method, in response to identifying (typically using voice recognition processing) that a received audio signal comprises: (i) a first part corresponding to a first transmitted audio signal of the one or more transmitted audio signals; and (ii) a second part corresponding to a second transmitted audio signal of the one or more transmitted audio signals, comprises splitting the received audio signal into a received audio signal comprising the first part, and at least one other audio signal comprising the second part.

The invention also provides apparatus corresponding to, and comprising elements, modules or components arranged to put into effect the above methods, for example one or more various suitably configured computing devices. In particular, the invention therefore provides a connectivity analysis system for radio network. The system comprises, a receiving module, arranged to receive, from each of the plurality of radio units, (a) respective audio signals for messages transmitted from the radio unit, and (b) respective received audio signals for messages received by the radio unit. A matching module arranged to identify, for each transmitted audio signal, the received audio signals for messages common to the transmitted audio signal and the received messages. A connectivity module arranged to generate one or more measures of connectivity between radio units of the plurality. The one or more measures of connectivity being generated based each of one or more each transmitted audio signals and the respective identified received audio signals.

The invention also provides one or more computer programs suitable for execution by one or more processors, such computer program(s) being arranged to put into effect the methods outlined above and described herein. The invention also provides one or more computer readable media, and/or data signals carried

### BRIEF DESCRIPTION OF THE DRAWINGS

Embodiments of the invention will now be described, by way of example only, with reference to the accompanying drawings, in which:

FIG. 1a schematically illustrates a number of users deployed in a field exercise using a radio network;

FIG. 1b schematically illustrates the field exercise of FIG. 1a at a later time;

FIG. 1c schematically illustrates an example connectivity analysis system for analysing the radio network in FIGS. 1a and 1b;

FIG. 2 schematically illustrates an example of a computer system suitable for implementing various aspects of the invention;

FIG. 3a illustrates a schematic diagram of a generalized system for putting the arrangement of FIGS. 1a and 1b into effect;

FIG. 3b illustrates a schematic diagram of a generalized system for putting the arrangement of FIG. 1c into effect;

FIGS. 4a-4d show example outputs of system as described with in FIG. 3b.

### DETAILED DESCRIPTION OF EMBODIMENTS OF THE INVENTION

In the description that follows and in the figures, certain embodiments of the invention are described. However, it will be appreciated that the invention is not limited to such embodiments and that some embodiments may not include all of the features that are described below. Various modifications and changes may also be made to these embodiments without departing from the broader spirit and scope of the invention, for example as set forth in the appended claims.

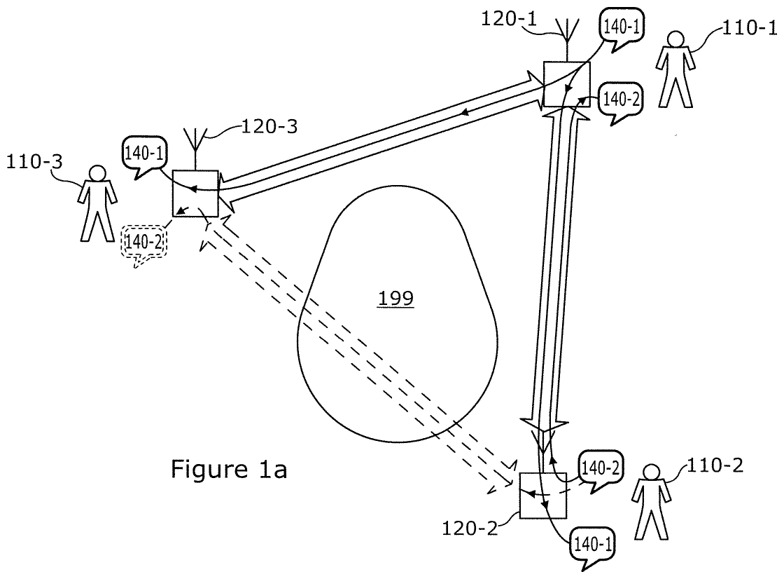

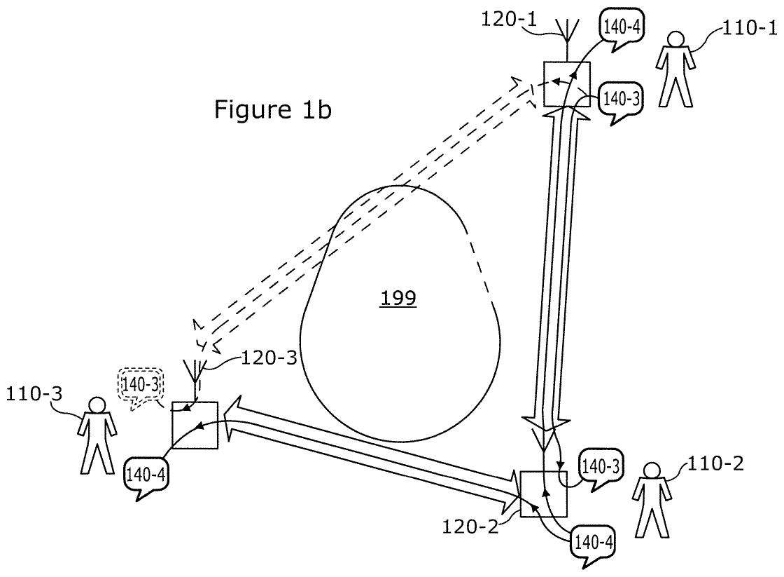

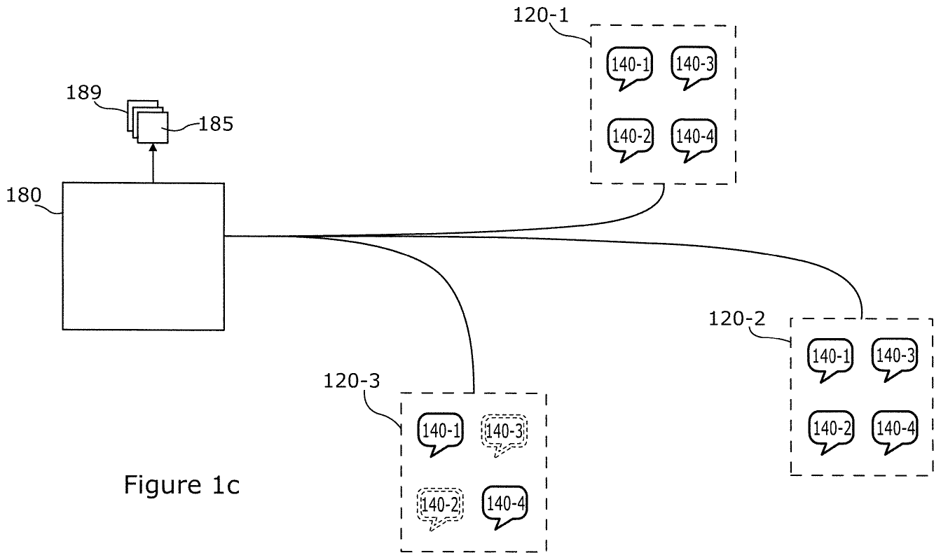

FIGS. 1a and 1b illustrate a situation in which users 110-1; 110-2; 110-3 of radio units 120-1; 120-2; 120-3 are taking part in in a field exercise. The users 110-1; 110-2; 110-3 wish to communicate with each other during the field exercise. For example, various orders may have to be issued by one or more of the users 110-1; 110-2; 110-3 during the field exercise, particular users 110-1; 110-2; 110-3 may need to inform other users 110-1; 110-2; 110-3 of changes in situation (such as locations of hostile forces spotted etc.), and so on. Communication between the users 110-1; 110-2; 110-3 is typically performed using the radio units 120-1; 120-2; 120-3 (often known as combat net radio units) carried by, or otherwise available to, the users 110-1; 110-2; 110-3.

To this end, messages 140-1; 140-2 (typically audio messages) can be broadcast between radio units 120-1; 120-2; 120-3 operating on the same radio channel (typically a frequency modulated or amplitude modulated system). A user 110-1; 110-2; 110-3 wishing to communicate with other users 110-1; 110-2; 110-3 is able to broadcast a message 140-1; 140-2 to the other users 110-1; 110-2; 110-3 via the radio units 120-1; 120-2; 120-3.

Messages 140-1; 140-2 may be affected by radio interference during broadcast (such as that caused by other radio transmissions, environmental factors such as terrain, distance travelled by the audio signal, and so on). In some situations a radio unit 120-2 cannot receive a message 140-2 broadcast by another radio unit 120-3, or the message received by the radio unit may be corrupted.

For example, as shown in FIG. 1a, a first user 110-1 may wish to broadcast a first message 140-1 (such as an order to move south) to the other users 110-2; 110-3. The first user 110-1 operates the radio unit 120-1 to transmit the first message 140-1. Each of the other radio units 120-2; 120-3 receive the first message 140-1 and play the received message back to the respective user 110-2; 110-3.

A second user 110-2 may then wish to broadcast a second message 140-2 (such as an order countermanding the move south) to the other users 110-1; 110-3. The second user 110-2 operates the radio unit 120-2 to transmit the second message 140-2. The first radio unit 120-1 receives the second message 140-2 and plays back the second message to the first user 110-1, completing the relaying of the second message 140-2 to the first user 110-1. However, the second message 140-2 received by the third radio unit 120-3 is corrupted due to interference. As a result, the relaying of the second message 140-2 to the third user 110-3 is not completed. In this case the corruption is due to the hill 199 positioned between the second radio unit 120-2 and the third radio unit 120-3.

As such, in this example, the first radio unit 120-1 and the second radio unit 120-2 are connected (shown by the solid arrow between the units) as a message 140-1 can be broadcast between the first and second radio units. The first radio unit 120-1 and the third radio unit 120-3 are connected (shown by the solid arrow between the units) as a message 140-1 can be broadcast between the first and third radio units. However, the second radio unit 120-1 and the third radio unit 120-3 are not connected (shown by the dashed arrow between the units) as a message 140-2 cannot be broadcast between the second and third radio units. This connectivity between the radio units 120-1; 120-2; 120-3 can change over time. In particular, anything which varies the relative positions of the radio units 120-1; 120-2; 120-3, or their effective ranges may alter the connectivity.

FIG. 1b shows a similar situation as FIG. 1a but at a later time. Here the third user 110-3 and the third radio unit 120-3 have moved to the south. As a result, the hill 199 is now positioned between the first radio unit 120-1 and the third radio unit 120-3, instead of between the second radio unit 120-2 and the third radio unit 120-3.

Now the first user 110-1 may wish to broadcast a further message 140-3 to the other users 110-2; 110-3. Now the further message 140-3 received by the third radio unit is corrupted. The second radio unit 120-2 receives the further message 140-3 and plays the received message back to the second user 110-2.

The second user 110-2 may then wish to broadcast a final message 140-4 to the other users 110-1; 110-3. The second user 110-2 operates the second radio unit 120-2 to transmit the final message 140-4. The first radio unit 120-1 receives the final message 140-4 and plays back the final message to the first user 110-1, completing the relaying of the final message 140-2 to the first user. Due to the change in relative positions, the third radio unit 120-3 now does receive the final message 140-4 and plays back the final message to the third user 110-3, completing the relaying of the final message 140-4 to the third user.

Therefore the first radio unit 120-1 and the third radio unit 120-3 are not now connected (shown by the dashed arrow between the units) as a message 140-4 cannot be broadcast between the first and third radio units. However, the second radio unit 120-2 and the third radio unit 120-3 are now connected (shown by the solid arrow between the units) as a message 140-4 can be broadcast between the second and third radio units.

Each radio unit 120-1; 120-2; 120-3 is arranged to record the messages 140-1; . . . ; 140-4 transmitted at, and the messages 140-1; . . . ; 140-4 received by, that radio unit. The recorded messages 140-1; . . . ; 140-4 are marked to identify the particular radio unit 120-1; 120-2; 120-3 that recorded them (typically using an ID or serial number of the radio unit 120-1; 120-2; 120-3). The recorded messages 140-1; . . . ; 140-4 may be marked with the position of the radio unit 120-1; 120-2; 120-3 that recorded them at the point of recording (such as by using a navigational satellite system receiver located on the radio unit 120-1; 120-2; 120-3). The recorded messages 140-1; . . . ; 140-4 may also be marked to indicate whether the messages 140-1; . . . ; 140-4 recorded by the radio unit 120-1; 120-2; 120-3 were transmitted or received by the radio unit 120-1; 120-2; 120-3. The recorded messages 140-1; . . . ; 140-4 may also be marked to indicate the order in which the message was transmitted or received by the radio unit 120-1; 120-2; 120-3 relative to the other messages recorded by that radio unit 120-1; 120-2; 120-3. The recorded messages 140-1; . . . ; 140-4 may also be marked with the time at which they were recorded (typically this takes the form of a timestamp).

FIG. 1c schematically illustrates an analysis system 180 that may be used with the radio units 120-1; 120-2; 120-3 shown in FIGS. 1a and 1b. The messages 140-1; . . . ; 140-4 recorded at each radio unit 120-1; 120-2; 120-3 are provided to the analysis system 180. This may typically be achieved using a direct connection with the radio unit 120-1; 120-2; 120-3 after the end of the field exercise. For example, by connecting each radio unit 120-1; 120-2; 120-3 individually, or in groups, using cables to effect data transfer. However, it will be appreciated that the recorded messages may be provided to the analysis system 180 during the exercise, for example using appropriate mobile data communication between the analysis system 180 and the radio units 120-1; 120-2; 120-3 such as a 3G data connection.

The analysis system 180 then matches common messages. In particular, for each recorded message 140-1; . . . ; 140-4 transmitted at a radio unit 120-1; 120-2; 120-3 the analysis system 180 is arranged to identify the corresponding recorded messages 140-1; . . . ; 140-4 received at other radio units 120-2; 120-3. In other words the analysis system 180 is arranged to group transmissions and their receipts from among the recorded messages 140-1; . . . ; 140-4. This matching is typically carried out using audio analytics. For example, the analysis system 180 may be arranged to perform audio fingerprint analytics on each recorded message so that the messages can be grouped based on similar or identical audio fingerprints.

The analysis system 180 may be arranged to generate measures of connectivity 185 between the radio units 120-1; 120-2; 120-3. Such measures of connectivity 185 may include any of: completion rates based on transmitted messages; effective transmission/reception ranges of each radio unit 120-1; 120-2; 120-3; measures of duration of messages received by a radio unit (such as maximum length, minimum length, average length, frequency of messages, count of messages, latency etc.), range for one or more radio units (or between one or more pairs of radio units), most active radio unit (such as by number of transmitted messages) and so on.

For example, a measure of connectivity 185 such as completion rate may be represented as a matrix with each element representing the completion rate between a respective pair of radio units. In particular, a value of 1 may represent a message transmitted by one of the pair of radio units was identical to the message received by the other radio unit of the pair. A value of 0 may indicate that no matching received message was identified. The average of these values over the transmissions made by the pair up to a given point in time may be thought of as the completion rate for that pair of radios at that point in time.

In another example, a measure of connectivity 185 such as the effective range of a radio may be represented as a value or group of values, based on the distance between a transmitting radio unit and other radio units which received the transmission. Such distance may be calculated using the position of the radio unit marked on the relevant recorded messages.

The generated measures of connectivity 185 are usually output by the analysis system 180 to an operator. Such output typically takes the form of one or 3 0 more graphs of the measure of connectivity 189. For example, the completion rates above may simply be outputted as a table showing the completion rate at a given time for each pair of radio units. Additionally, or alternatively a graph 189 showing the change in completion rate over time for a particular pair (or the completion rates for a number of pairs) may be output to the operator.

In another example, the effective range for each radio unit may be output as a table of effective ranges. Additionally, or alternatively the effective ranges may be plot on a geographic representation of the deployment location of the radios. This may take the form of a respective circle for each radio unit, centred on the radio unit, where the circle has a radius based on the effective range of the radio unit.

It will be appreciated that the measures of connectivity 185 may change as the positions of the radio units change over time, and as further messages are broadcast. In this way the measures of connectivity 185 generated may be time dependent. As such, the time-dependent measures of connectivity 185 may be output accordingly. For example, the one or more graphs may be of the form of a time series. Where the one or more graphs include a plot on a geographic representation of the deployment location of the radios, the plot may be animated to show the time evolution of the positions of the radios and the measure of connectivity 185.

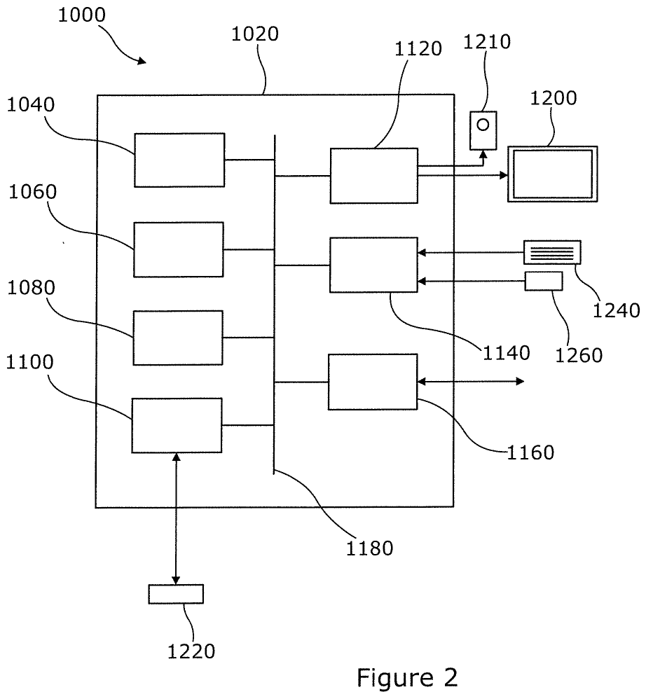

FIG. 2 schematically illustrates an example of a computer system 1000 which may be used to implement systems of the invention, such as the analysis system 180. The system 1000 comprises a computer 1020. The computer 1020 comprises: a storage medium 1040, a memory 1060, a processor 1080, an interface 1100, a user output interface 1120, a user input interface 1140 and a network interface 1160, which are all linked together over one or more communication buses 1180.

The storage medium 1040 may be any form of non-volatile data storage device such as one or more of a hard disk drive, a magnetic disc, an optical disc, a ROM, etc. The storage medium 1040 may store an operating system for the processor 1080 to execute in order for the computer 1020 to function. The storage medium 1040 may also store one or more computer programs (or software or instructions or code).

The memory 1060 may be any random access memory (storage unit or volatile storage medium) suitable for storing data and/or computer programs (or software or instructions or code).

The processor 1080 may be any data processing unit suitable for executing one or more computer programs (such as those stored on the storage medium 1040 and/or in the memory 1060), some of which may be computer programs according to embodiments of the invention or computer programs that, when executed by the processor 1080, cause the processor 1080 to carry out a method according to an embodiment of the invention and configure the system 1000 to be a system according to an embodiment of the invention. The processor 1080 may comprise a single data processing unit or multiple data processing units operating in parallel or in cooperation with each other. The processor 1080, in carrying out data processing operations for embodiments of the invention, may store data to and/or read data from the storage medium 1040 is and/or the memory 1060.

The interface 1100 may be any unit for providing an interface to a device 1220 external to, or removable from, the computer 1020. The device 1220 may be a data storage device, for example, one or more of an optical disc, a magnetic disc, a solid-state-storage device, etc. The device 1220 may have processing capabilities—for example, the device may be a smart card. The interface 1100 may therefore access data from, or provide data to, or interface with, the device 1220 in accordance with one or more commands that it receives from the processor 1080.

The user input interface 1140 is arranged to receive input from a user, or operator, of the system 1000. The user may provide this input via one or more input devices of the system 1000, such as a mouse (or other pointing device) 1260 and/or a keyboard 1240, that are connected to, or in communication with, the user input interface 1140. However, it will be appreciated that the user may provide input to the computer 1020 via one or more additional or alternative input devices (such as a touch screen). The computer 1020 may store the input received from the input devices via the user input interface 1140 in the memory 1060 for the processor 1080 to subsequently access and process, or may pass it straight to the processor 1080, so that the processor 1080 can respond to the user input accordingly.

The user output interface 1120 is arranged to provide a graphical/visual and/or audio output to a user, or operator, of the system 1000. As such, the processor 1080 may be arranged to instruct the user output interface 1120 to form an image/video signal representing a desired graphical output, and to provide this signal to a monitor (or screen or display unit) 1200 of the system 1000 that is connected to the user output interface 1120. Additionally or alternatively, the processor 1080 may be arranged to instruct the user output interface 1120 to form an audio signal representing a desired audio output, and to provide this signal to one or more speakers 1210 of the system 1000 that is connected to the user output interface 1120.

Finally, the network interface 1160 provides functionality for the computer 1020 to download data from and/or upload data to one or more data communication networks.

It will be appreciated that the architecture of the system 1000 illustrated in FIG. 2 and described above is merely exemplary and that other computer systems 1000 with different architectures (for example with fewer components than shown in FIG. 1 or with additional and/or alternative components than shown in FIG. 1) may be used in embodiments of the invention. As examples, the computer system 1000 could comprise one or more of: a personal computer; a server computer; a mobile telephone; a tablet; a laptop; other mobile devices or consumer electronics devices; etc.

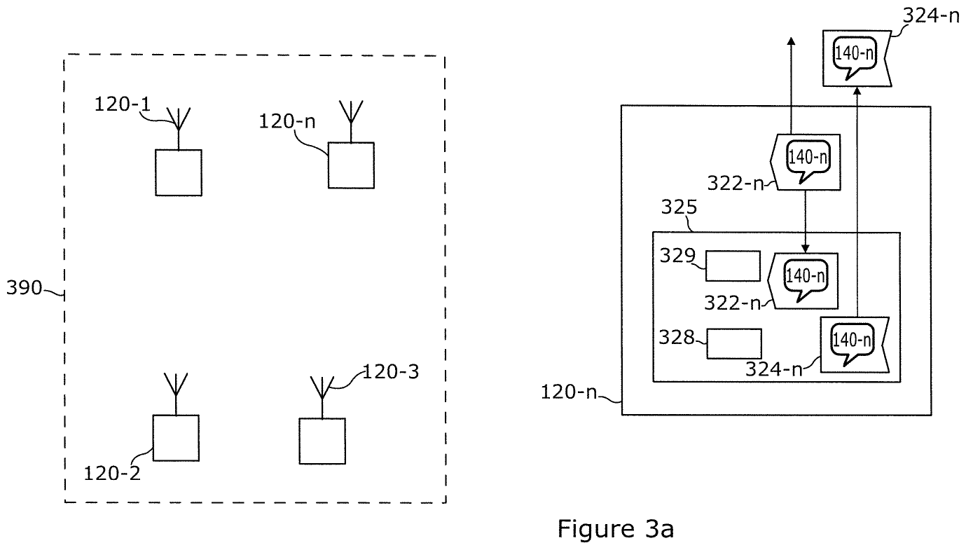

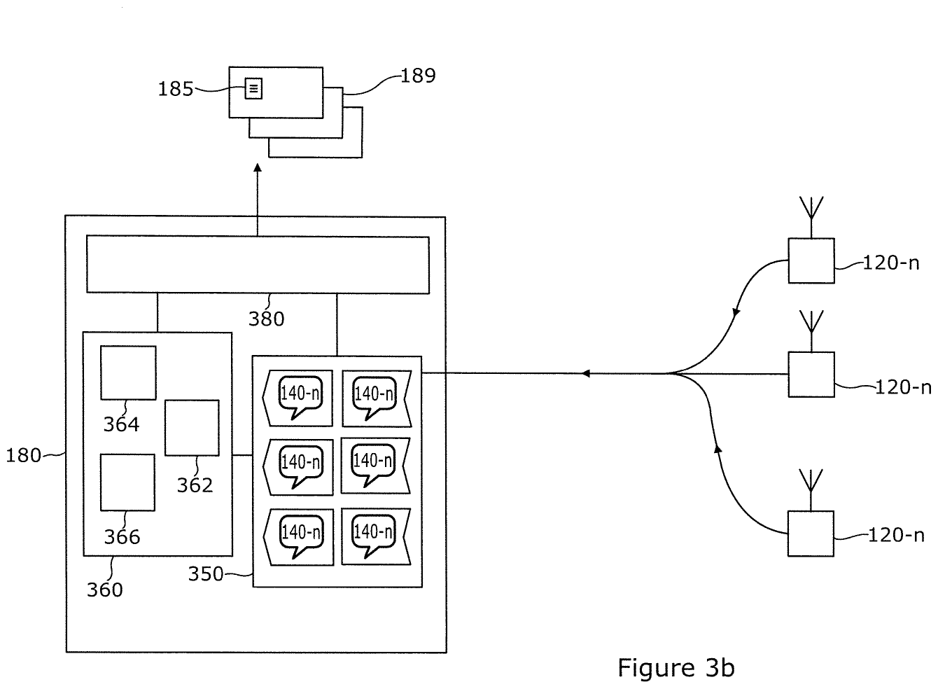

A more detailed description of ways in which an arrangement such that illustrated in FIGS. 1a-1c may be put into effect, to enable the generation of measures of connectivity between the radio units, is illustrated schematically in FIGS. 3a and 3b, discussed below. FIG. 3a shows an example radio network 390 comprising a plurality of radio units 120-1; 120-2; . . . ; 120-n which may be deployed in a geographical locale and used over a period of time. For ease of understanding the functionality of the radio units 120-1; 120-2;

120-3; . . . ; 120-n of the plurality of radio units will be described below with reference to a single radio unit 120-n. It will, however, be appreciated that this discussion may apply to any radio unit 120-1; 120-2; 120-3; . . . ; 120-n of the plurality of radio units.

A radio unit 120-n is operable to transmit and/or receive an audio signal via radio (i.e. using electromagnetic waves in the radio frequency range). In particular, the radio unit 120-n is operable to transmit and/or receive speech via radio. Such a radio unit may be referred to as a “radiotelephone”. The radio unit 120-n is typically arranged to transmit and/or receive using a particular radio channel. Often the radio unit will enable the user of the radio unit to select a radio channel for use from a plurality of radio channels. An audio signal 322-n; 324-n transmitted on a given radio channel may, in principle, be received by a radio unit 120-n arranged to receive using the given channel.

It will therefore be appreciated that a plurality of radio units each operating on the same radio channel may transmit (or broadcast) audio signals to each other. As such, a group of radio units operating on the same radio channel may form part of a radio network 390.

A radio unit 120-n which can both transmit and receive audio signals may be referred to as a “two-way radio”. Typically the radio unit 120-n will be of a “half duplex” type. In other words a radio unit 120-n may transmit one or more audio signals 322-n, and it may receive one or more audio signals 324-n, but it may not transmit and receive simultaneously. The radio unit 120-n is usually operable to play back a received audio signal 324-n to a user of the radio unit 120-n (such as via a speaker or earpiece).

The radio unit 120-n may make use frequency modulation or amplitude modulation for transmission/reception. The radio unit 120-n may use multiplexing, in particular any of: code division multiplexing, time division multiplexing, or frequency division multiplexing.

The radio unit 120-n comprises a recording module 325 (or capture unit). The recording module 325 is arranged to record audio signals received at the radio unit 120-n. The recording module 325 is arranged to record audio signals transmitted from the radio unit 120-n. The recording module 325 may be part of the radio unit 120-n. Alternatively, the recording module 325 may be an external module (or unit) attached to the radio unit 120-n. For example, the recording module 325 may be attached to an audio input and/or audio output of the radio unit 120-n. In this way it will be understood that in some examples, the recording module may be a self-contained (or separate) capture unit that can be used with any radio unit having a suitable audio input and/or audio output for connection to the capture unit. Typically a capture unit is connected to the audio input and/or audio output of a radio unit by one or more cables of a suitable type. Examples include any of: standard audio cables provided with headphone jacks or DIN connectors, data cables, and so on. An advantage of the recording module being such a self-contained capture unit is that the invention may be used with existing radio units and radio networks.

The recording module 325 typically comprises a data storage device (such as a solid state storage device, or a magnetic storage device) for storing the recorded audio signals.

The recording module 325 may comprise a positioning module 328 arranged to calculate (or otherwise obtain) a current position of the radio unit 120-n. The positioning module 328 may use any suitable positioning system including any global navigational satellite system such as any one or more of: GPS, GLONASS, Galileo, BeiDou, and so on. The positioning module 328 may be arranged to tag (or mark or store or otherwise associate) each audio signal 322-n; 324-n with the position (or coordinates) of the radio unit 120-n when the audio signal 322-n; 324-n was received by, or transmitted from, the radio unit 120-n.

Additionally, or alternatively, the recording module may comprise a timing module 329. The timing module 329 is arranged to timestamp each recorded audio signal 322-n; 324-n with the time at which the audio signal 322-n; 324-n was received by, or transmitted from, the radio unit 120-n. The timing module 329 may be arranged to use a time source internal to the radio unit 120-n or the recording module (such as a system clock). The timing module 329 may, alternatively, be arranged to use an external time source such as a radio time code or the time provided by a global navigational satellite system (such as any of those described above). It will be appreciated that in some embodiments the functionality of the timing module 329 may be provided by the positioning module 328, such as when the time source is provided by a global navigational satellite system.

Usually the recording module 325 is arranged to mark (or tag or store or otherwise associate) each recorded audio signal 322-n; 324-n with an identifier, identifying the radio unit 120-n from the other radio units of the plurality.

As set out above, a radio network formed by the plurality of radio units 120-n may be used in the broadcasting of messages 140-n between the radio units 120-n. A message 140-n is typically broadcast as an audio signal, such as a signal representing (or encoding) speech. To this end, an audio signal 322-n; 324-n corresponds to at least one message. The audio signal 322-n; 324-n typically comprises a voice recording of a message 140-n. The audio signal 322-n; 324-n may be an analogue signal or a digital signal. The audio signal 322-n; 324-n may be compressed using any suitable audio compression scheme (or codec).

An audio signal 324-n received at a radio unit 120-n will usually correspond to an audio signal 322-n transmitted by another radio unit. The received audio signal 324-n may be degraded (or distorted or attenuated or otherwise changed) with respect to the transmitted audio signal 322-n due to radio interference. Such radio interference may be the result of any one or more of: signal loss due to the distance travelled by the audio signal; deflection and/or reflection due to objects in the transmission path of the signal; concurrent radio transmissions on the same radio channel; atmospheric conditions affecting radio wave propagation; and so on.

Such degradation of the audio signal 324-n may affect the message 140-n of the audio signal 324-n. The message 140-n of a degraded audio signal 324-n received at a radio unit 120-n may be corrupted. In some embodiments a received message 140-n may be considered corrupted if any part of the transmitted message 140-n is not present (or inaudible) in the received message 140-n. Alternatively, a received message 140-n may be considered corrupted if more than a pre-determined amount of the transmitted message 140-n is not present (or inaudible) in the received message. For example, a pre-determined threshold may be used, such that if more than said threshold of the transmitted message 140-n is not present in the received message 140-n then the received message 140-n is considered corrupted.

Additionally or alternatively, in some embodiments messages 140-n may be required to contain essential parts (or elements). For example, these may be any of a callsign; a terminator for the message, a codeword etc. A received message 140-n may be considered corrupted if an essential part present in the transmitted message 140-n is not present in the received message 140-n.

FIG. 3b schematically illustrates an analysis system 180 operable with the plurality of radios 120-n shown in FIG. 3a.

The analysis system 180 may be implemented using one or more computer systems 1000. The analysis system 180 typically comprises an audio signal storage module 350, an audio analysis module 360 and a connectivity module 380.

The audio signal storage module 350 is arranged to store the audio signals 322-n; 324-n recorded at the radio units 120-n. The analysis system 180 may be arranged to obtain (or acquire or receive) the audio signals 322-n; 324-n from each radio unit 120-n via a direct connection with each radio unit 120-n. A direct connection may comprise a wired connection (such as a USB connection, a Firewire connection, etc.) and/or a wireless connection (such as a Bluetooth connection; a WiFi connection, a 3G data connection etc.). In embodiments where the data storage of the recording module 325 is removable (such as removable solid state storage, for example any of an SD card, microSD card or similar) the data storage may be connected directly to the analysis system 180 via suitable interface (such as an SD card slot).

The analysis system 180 may be arranged to mark (or tag or store or otherwise associate) each audio signal 322-n; 324-n stored in the audio signal storage module 350 with an identifier, identifying the radio unit 120-n at which the audio signal 322-n; 324-n was recorded.

The audio analysis module 360 is arranged to perform audio analysis on the audio signals 322-n; 324-n stored in the audio signal storage module 350. In particular, the audio analysis module 360 may be arranged to identify one or more messages 140-n of an audio signal 322-n; 324-n. The voice analysis module 360 may be arranged to split an audio signal 322-n; 324-n of two or more messages 140-n into separate audio signals 322-n; 324-n each of a single message 140-n. It will be appreciated that more than one message 140-n may be identified by the presence of a pause (or gap or other message delineator) in the audio signal 322-n; 324-n. Additionally, or alternatively, more than one message 140-n may be identified by the presence of more than one voice being present in an audio signal 322-n; 324-n. To that end, the audio analysis module 360 may be arranged to use voice recognition to identify more than one voice for an audio signal.

The audio analysis module 360 may be arranged to tag an audio signal 322-n; 324-n with a voice signature. The voice signature may be generated using a voice recognition algorithm (or system). The voice signature is an identifier (or other marker) that can be used to identify the voice on a particular audio signal 322-n; 324-n. The operation of voice recognition algorithms is well known and not described further herein. The voice recognition functionality may be provided in an optional voice recognition module 362.

The audio analysis module 360 may be arranged to use automatic speech recognition. Such automatic speech recognition functionality may be provided in an optional speech recognition module 364. In particular, the audio analysis module may be arranged to generate (or extract or otherwise transcribe) a transcript for a message 140-n in the audio signal. Typically, such automatic speech recognition involves taking a recording of speech (such as an audio signal as described above) and, using a computer model, generate a text of the words spoken. Automatic speech recognition techniques are well known and not described any further herein. The audio analysis module 360 may be further arranged to tag the audio signal 322-n; 324-n with the message transcript 345-n.

The audio analysis module may be arranged to perform further analysis on the audio signals 322-n; 324-n. The further analysis may comprise categorising an audio signal 322-n; 324-n based on the message 140-n of the audio signal 322-n; 324-n. For example, such further analysis may include detecting (or identifying) pre-determined words (and/or phrases) indicative of a category of the message of the audio signal 322-n; 324-n. The voice analysis module may be arranged to tag the audio signal 322-n; 324-n with the category of the message 140-n.

It will be appreciated that the specifics of the categories may be dependent on the nature of the use of the radio units 120-n. For example in a military context, messages 140-n may be categorized as to message purpose and/or message content. The categories for message content may comprise: order; report; request-for-information; etc. Here, an “order” message may be one that contains an order or a command. An example “order” may comprise the words ‘Move now.’ A “report” message may be one reporting information or status. An example “report” may comprise the words ‘Enemy sighted at’ A “request-for-information” message may be one requesting information. An example “request-for-information” may comprise the words ‘Where are you?’ It will be appreciated that a given message 140-n (and/or audio signal 322-n; 324-n) may be tagged with more than one category.

The audio analysis module 360 is arranged to identify audio signals 322-n; 324-n for a common message 140-n. Typically, for a transmitted audio signal 322-n with a given message 140-n, the message matching module 370 is arranged to identify the received audio signals 324-n with messages 140-n that match the given message 140-n. This may be thought of as linking the transmitted audio signal 322-n with each of the matched received audio signals 324-n. The audio analysis module 360 is typically arranged to perform an audio analytics comparison of a given transmitted audio signal 322-n with one or more received audio signals 324-n, to thereby identify the received audio signals 324-n with messages 140-n that match the message 140-n of the given transmitted audio signal 322-n.

The audio analytics comparison may comprise (or be based on) audio (or acoustic) fingerprint analysis. To that end, the audio analysis module 360 may be arranged to perform an audio fingerprint comparison of the transmitted and received audio signals. Such audio fingerprinting functionality may be provided in an optional audio fingerprinting module 366. For example, the audio fingerprinting module 366 may be arranged to perform audio fingerprint processing on the audio signals to generate respective audio fingerprint data. The audio analytics comparison may comprise comparing the audio fingerprint data for a given transmitted audio signal with the audio fingerprint data of one or more received audio signals.

It will be appreciated that the use of audio fingerprinting typically allows accurate matching of audio signals, even where the signals have been subject to distortion or radio interference. A suitable audio fingerprinting system for carrying out said audio fingerprinting would be the Multimedia Audio Duplication and Content Analysis Tool (MADCAT) available from Oxford Wave Research, United Kingdom. Other suitable audio fingerprinting tools and/or systems would be known to the skilled person. Audio fingerprint techniques are known in the art and not discussed further herein.

Additionally, or alternatively, the audio analysis module 360 may be arranged to compare a transcript generated for the transmitted audio signal 322-n to the transcript generated for a candidate received audio signal 324-n. The criteria for matching may be considered analogous to the criteria for a message 140-n being corrupted as set out above. A received audio signal 324-n may be considered to have a message 140-n common to (or matching with) a transmitted audio signal 322-n if more than a pre-determined amount of the transmitted message 140-n is present in the received message 140-n.

Additionally or alternatively, in some embodiments messages 140-n may be required to contain essential parts (or elements). For example, these may be any of a callsign; a terminator for the message; a codeword etc. A received audio signal 324-n may be considered not to have a message 140-n common with a transmitted audio signal 322-n if an essential part present in the transmitted message 140-n is not present in the received message 140-n.

It will be appreciated that any of the matching and/or comparison set out above may use one or more respective thresholds. Such thresholds may set a minimum required similarity for a given measure above which messages for different audio signals are considered the same (or common).

Additionally or alternatively, in some embodiments a received audio signal 324-n may be required to have the same voice signature as a transmitted audio signal 322-n, for the identified received audio signal 324-n to match the transmitted audio signal 322-n. To this end the audio analysis module 360 may be arranged to, to compare a voice signature for the transmitted audio signal 322-n to the voice signature for a candidate received audio signal 324-n.

The audio analysis module 360 may be arranged to for each match, generate a link between the respective transmitted audio signal 322-n and the matched received audio signal 324-n. It will be appreciated that a link may be stored in any number of different ways, including but not limited to: as part of one or both of the transmitted and matched received audio signals 322-n; 324-n; as part of a relational database; as part of a file separate from the transmitted and matched received audio signals, etc.

In this way it will be appreciated that the audio analysis module 360 is effectively identifying which received audio signals 324-n are successful receipts of a given transmitted audio signal 322-n.

The connectivity module 380 is further arranged to generate one or more measures of connectivity 185 between radio units 120-n. A measure of connectivity 185 may be generated based on the audio signals 322-n; 324-n with common messages 140-n.

A measure of connectivity 185 may comprise a completion rate. A completion rate may be thought of as the proportion (or ratio) of messages 140-n broadcast by first radio unit 120-n successfully received by a second radio unit 120-n. The connectivity module 380 may be arranged to generate a completion rate for each pair of radio units 120-n of the plurality of radio units based on the audio signals transmitted by each radio unit 120-n of the pair and the matching audio signals received by each radio unit 120-n of the pair. In other words, the completion rate may be based on the number of audio signals 322-n transmitted by each radio unit and the number of links between the transmitted audio signals 322-n and the audio signals 324-n received at each radio unit 120-n. Typically, the completion rates may be represented as a matrix with each element representing completion rate between a respective pair of radio units 120-n.

It will be appreciated that a completion rate may be calculated for a single radio unit 120-n. This may be termed an aggregate completion rate. An aggregate completion rate for a radio unit 120-n may be the proportion of other radio units that successfully receive a given transmitted audio signal from the radio unit 120-n. This may be an average across all transmitted audio signals from the radio unit 120-n.

A completion rate may be calculated for the network 390. This may be termed network completion rate. A network completion rate may be the proportion of radio units in the network that successfully receive a given transmitted audio signal from a radio unit 120-n in the network. This may be an average across all transmitted audio signals from all radio units 120-n in the network.

A measure of connectivity 185 may comprise an effective range. The connectivity module 380 may be arranged to generate an effective range for a radio unit 120-n. The effective range for a radio unit 120-n may comprise an effective transmission range and/or an effective reception range. The effective transmission range may be generated based on a difference (or distance between) the geographical position stored with audio signals 322-n transmitted by the radio unit 120-n and the geographical positions stored with matched received audio signals 324-n. The effective transmission range may comprise any one or more of, a maximum distance, a minimum distance, an average distance and so on.

Similarly, the effective reception range may be generated based on a difference (or distance between) the geographical position stored with audio signals 322-n transmitted by other radio units 120-n and the geographical positions stored with matched received audio signals 324-n received by the radio unit 120-n. The effective reception range may comprise any one or more of, a maximum distance, a minimum distance, an average distance and so on.

In this way it will be appreciated that a measure of connectivity 185 may be thought of as a metric or performance indicator relating to the ability of one or more radio units to effectively communicate with other radio units.

It will be appreciated that a measure of connectivity 185 (including any of the above mentioned measures of connectivity) may change over the period of time in which the radio units 120-n are deployed. As such, the connectivity module 380 may be arranged to generate the measures of connectivity as time-dependent measures of connectivity 185. Typically, the connectivity module 380 is arranged to generate measures of connectivity for a plurality of different points in time. This can be achieved by the connectivity module 380 generating the measure of connectivity 185 for a given point in time based on audio signals transmitted or received substantially at and/or before that point in time. Timestamps and/or the audio signal order of the audio signals as discussed above may be used for this purpose.

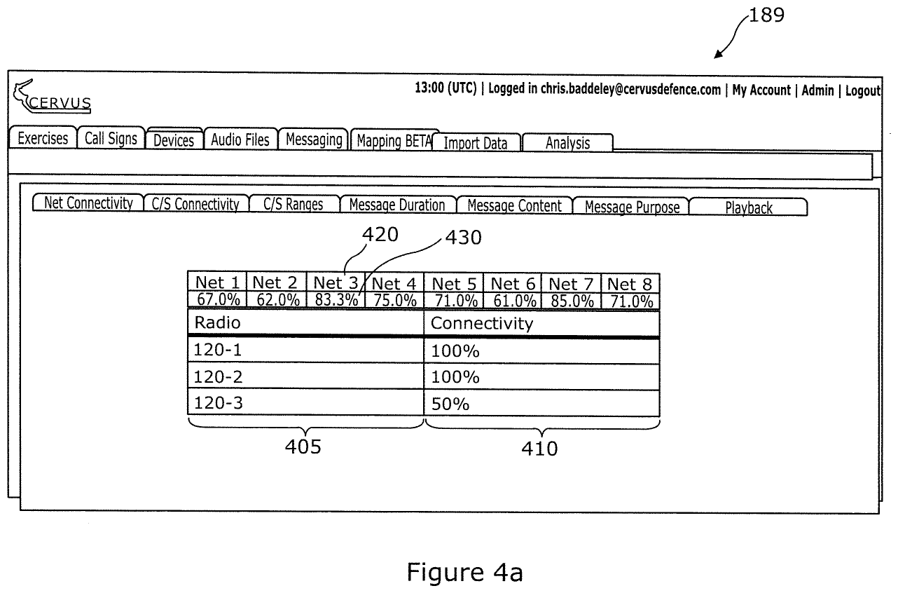

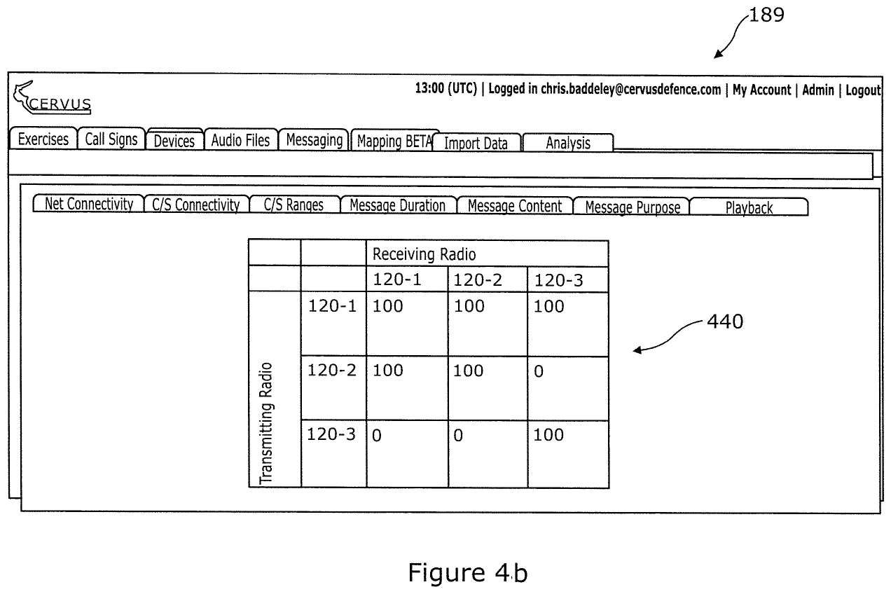

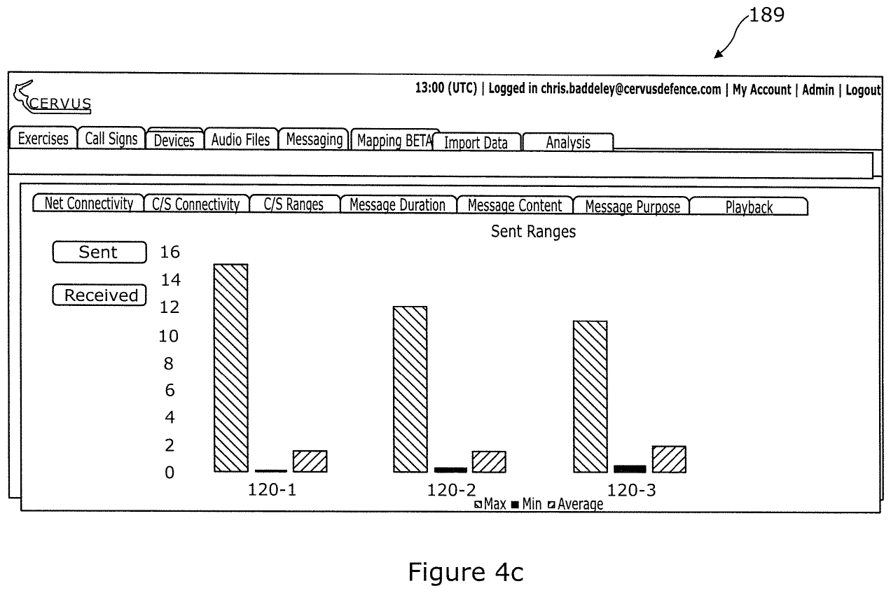

FIGS. 4a-4c show example outputs 189 of system 300 as described with reference to FIG. 3b.

FIG. 4a shows an example output 189 of system 300 comprising total completion rates for a plurality of radios 120-n on a particular network 420. The column 410 lists the completion rate for each radio 120-n in the network as a percentage. The radio units 120-n are listed in column 405 using the respective identifier of the radio unit 120-n.

The completion rates for each radio 120-n are shown in the column 410. As can be seen a single completion rate is shown for each radio unit 120-n. as such, in this example the completion rates in column 410 are aggregate completion rates as described previously. A network completion rate 430 is also shown for the network 420 of the radio units 120-n. The network completion rate is calculated as set out previously. In this case the completion rates are calculated over the entire duration of the deployment of the radio units 120-n.

FIG. 4b shows an example output 189 of system 300 comprising a table (or matrix) 440 showing the completion rate for each pair of radios that are part of a given network. The radio units 120-n are listed using the respective identifier of the radio unit 120-n. The completion rate for each pair of radios is calculated as described above. In particular, in this example the completion rate is a number between 0 and 1 indicating the proportion of messages transmitted by a radio unit in the pair that were successfully received by the other radio unit in the pair. In this case the completion rates are calculated over the entire duration of the deployment of the radio units 120-n.

FIG. 4c shows an example output 189 of system 300 comprising a bar chart showing the effective range for each radio unit 120-n. The radio units 120-n are listed using the respective identifier of the radio unit 120-n. For each radio unit a maximum, minimum and average range in metres for messages transmitted by the radio unit. The ranges are calculated as described previously. In this case ranges are calculated with respect to the entire duration of the deployment of the radio units 120-n.

The connectivity analysis described above has been described as occurring at the end of the deployment of the radio units. However, the skilled person will appreciate that this is not a limitation of the invention and that ongoing connectivity analysis (for example in a field exercise scenario) is possible and may be desirable. To this end the recording modules 325 and/or radio units may be provided with a secondary communication channel (such as a mobile telephony communication channel) to provide recorded audio signals 322-n; 324-n to the analysis system 180 in real time.

Whilst the above methods and systems are described with reference to combat net radio systems it will be appreciated that they could be applied to any voice carrying radio network, such as two way radio systems used by emergency services, civilian security services etc.

It will be appreciated that the methods described have been shown as individual steps carried out in a specific order. However, the skilled person will appreciate that these steps may be combined or carried out in a different order whilst still achieving the desired result.

It will be appreciated that embodiments of the invention may be implemented using a variety of different information processing systems. In particular, although the figures and the discussion thereof provide an exemplary computing system and methods, these are presented merely to provide a useful reference in discussing various aspects of the invention. Embodiments of the invention may be carried out on any suitable data processing device, such as a personal computer, laptop, personal digital assistant, mobile telephone, server computer, etc. Of course, the description of the systems and methods has been simplified for purposes of discussion, and they are just one of many different types of system and method that may be used for embodiments of the invention. It will be appreciated that the boundaries between logic blocks are merely illustrative and that alternative embodiments may merge logic blocks or elements, or may impose an alternate decomposition of functionality upon various logic blocks or elements.

It will be appreciated that the above-mentioned functionality may be implemented as one or more corresponding modules as hardware and/or software. For example, the above-mentioned functionality may be implemented as one or more software components for execution by a processor of the system. Alternatively, the above-mentioned functionality may be implemented as hardware, such as on one or more field-programmable-gate-arrays (FPGAs), and/or one or more application-specific-integrated-circuits (ASICs), and/or one or more digital-signal-processors (DSPs), and/or other hardware arrangements. Method steps implemented in flowcharts contained herein, or as described above, may each be implemented by corresponding respective modules; multiple method steps implemented in flowcharts contained herein, or as described above, may be implemented together by a single module.

It will be appreciated that, insofar as embodiments of the invention are implemented by a computer program, then a storage medium and a transmission medium carrying the computer program form aspects of the invention. The computer program may have one or more program instructions, or program code, which, when executed by a computer carries out an embodiment of the invention. The term “program” as used herein, may be a sequence of instructions designed for execution on a computer system, and may include a subroutine, a function, a procedure, a module, an object method, an object implementation, an executable application, an applet, a servlet, source code, object code, a shared library, a dynamic linked library, and/or other sequences of instructions designed for execution on a computer system. The storage medium may be a magnetic disc (such as a hard drive or a floppy disc), an optical disc (such as a CD-ROM, a DVD-ROM or a BluRay disc), or a memory (such as a ROM, a RAM, EEPROM, EPROM, Flash memory or a portable/removable memory device), etc. The transmission medium may be a communications signal, a data broadcast, a communications link between two or more computers, etc.

1. A method of capturing audio data exchanged in the operation of a combat net radio network, the combat net radio network comprising a plurality of radio units deployed in a field exercise, each combat net radio unit operable to transmit and receive messages as audio signals, the method comprising:
recording, at each of one or more radio units of the plurality of radio units, respective transmitted audio signals for messages transmitted by the radio unit;
recording, at each of one or more radio units of the plurality of radio units, respective received audio signals for messages received by the receiving radio unit; and
identifying for each of at least some of the transmitted audio signals, correspondence between the transmitted audio signals and one or more received audio signals for the same message as transmitted audio signal; and
generating one or more measures of connectivity between radio units of the plurality from the identified correspondence of transmitted and received audio signals.

2. The method according to claim 1, the method further comprising:
at each radio unit recording a series of geographical coordinates of the radio unit during the field exercise for the transmitted audio signals and the received audio signals at said radio unit.

3. A method of connectivity analysis of a combat net radio network, the combat net radio network comprising a plurality of radio units deployed in a field exercise, each combat net radio unit operable to transmit and receive messages as audio signals, the method comprising:
receiving from each of the plurality of radio units,
(a) respective transmitted audio signals for messages transmitted from the radio unit; and
(b) respective received audio signals for messages received by the radio unit;
identifying, for each transmitted audio signal, the received audio signals for messages common to the transmitted audio signal and the received audio signals, to thereby generate one or more measures of connectivity between radio units of the plurality.

4. The method according to claim 3, each of the transmitted audio signals and the received audio signals is associated with geographical coordinates of the respective radio unit representing the positon position of the radio unit when recording the audio signal.

5. The method according to claim, wherein the series of geographical coordinates include one or more timestamps based on a timing source common to the radio units.

6. The method according to claim 4, wherein the connectivity measure comprises a respective range for each radio unit, based at least in part on the geographical coordinates recorded for the parts of the received audio signals of the other radio units identified as corresponding to transmitted audio signals of the radio unit.

7. The method according to claim 3, the method further comprising outputting a graph of connectivity between radio units of the plurality based on the measures of connectivity.

8. The method according to claim 7, wherein the graph representing time dependent measure of connectivity measure comprises a respective completion rate for each transmitted audio signal.

9. The method according to claim 7, wherein said outputting comprises plotting, using the series of geographical coordinates recorded at the radio units, at least part of the connectivity measure onto a topographical representation of a locale in which the radio units are deployed.

10. The method according to claim 9, wherein said plotting comprises indicating the respective range for one or more of the radio units.

11. The method according to claim 3, wherein said identifying is based on an audio analytics comparison of the transmitted audio signal and the received audio signals.

12. The method according to claim 11 wherein said audio analytics comparison is based at least in part on performing audio fingerprint processing on the transmitted audio signal and the received audio signals.

13. The method according to claim 12 wherein said audio analytics comparison comprises:
performing audio fingerprint processing on the transmitted audio signal to generate audio fingerprint data for the message of the transmitted audio signal;
comparing the audio fingerprint data for the transmitted audio signal with audio fingerprint data for the received audio signals.

14. The method according to claim 11 wherein said audio analytics comparison is based at least in part on performing voice recognition processing on the transmitted audio signal and the received audio signals.

15. The method according to the preceding claim 3 further comprising:
performing automatic speech recognition processing on a transmitted audio signal to generate a message transcript for the message of the transmitted audio signal; and
associating the message transcript with each received audio signal identified as being an audio signal for the message.

16. The method according to claim 15, the method further comprising associating one or more message categories with the audio signals based on the respective message transcript of the respective messages of the audio signals.

17. The method according to claim 3, wherein the method further comprises, in response to identifying that a received audio signal comprises:
(i) a first part corresponding to a first transmitted audio signal of the one or more transmitted audio signals; and
(ii) a second part corresponding to a second transmitted audio signal of the one or more transmitted audio signals,
splitting the received audio signal into a received audio signal comprising the first part, and at least one other audio signal comprising the second part.

18. (canceled)

19. (canceled)

20. (canceled)

21. A connectivity analysis system for a combat net radio network, the combat net radio network comprising a plurality of radio units deployed in a field exercise, each combat net radio unit operable to transmit and receive messages as audio signals, the system comprising:
a set of one or more processors and a set of one or more non-transient computer-readable media storing instructions which when executed by the set of processors cause the processors to perform the following operations:
receive, from each of the plurality of radio units,
(a) respective audio signals for messages transmitted from the radio unit; and
(b) respective received audio signals for messages received by the radio unit;
identify, for each transmitted audio signal, the received audio signals for messages common to the transmitted audio signal and the received messages;
generate one or more measures of connectivity between radio units of the plurality based each of one or more each transmitted audio signals and the respective identified received audio signals.

22. (canceled)

23. (canceled)
